(19) United States
(12) Patent Application Publication
(10) Pub. No.: US 2025/0306237 A1
(43) Pub. Date: Oct. 2, 2025

(54) Parameter Determination Method and Apparatus for Uranium Fission Prompt Neutron Logging Model, and Storage Medium

(71) Applicant: Airborne Survey and Remote Sensing Center of Nuclear Industry, Shijiazhuang City (CN)

(72) Inventors: Guolin Gao, Shijiazhuang City (CN); Changxing Zhang, Shijiazhuang City (CN); Jiyun Zhang, Shijiazhuang City (CN); Changfeng Shen, Shijiazhuang City (CN); Shaobin Guan, Shijiazhuang City (CN); Xiaochuan Tang, Shijiazhuang City (CN); Gengwu Jia, Shijiazhuang City (CN)

(21) Appl. No.: 18/796,858

(22) Filed: Aug. 7, 2024

(30) Foreign Application Priority Data
Apr. 1, 2024 (CN) 202410385945.3

(51) Int. Cl. G01V 20/00; G01V 5/10

(52) U.S. Cl. CPC G01V 20/00; G01V 5/10

(57) ABSTRACT

The present disclosure relates to a parameter determination method and apparatus for a uranium fission prompt neutron logging model, and a storage medium, which include: determining starting time, terminating time and a time window of a uranium fission prompt neutron of each neutron type by constructing the uranium fission prompt neutron logging model, setting quantitative parameters and exploration areas of the model, simulating and calculating flux time spectra of a plurality of neutron types under different variable parameters and comparing the time spectrum of the uranium fission prompt neutron with a background time spectrum; determining an accumulated flux of each neutron according to the starting time, terminating time and time window; setting a reference pore diameter, a reference ore-bearing model diameter and a reference ore-bearing model thickness; and determining the model pore diameter, ore-bearing model diameter and ore-bearing model thickness in respective.

### CROSS REFERENCE TO RELATED APPLICATION

This application claims the benefit of and takes priority from Chinese Patent Application No. 202410385945.3 filed on Apr. 1, 2024, the contents of which are herein incorporated by reference.

### TECHNICAL FIELD

The present disclosure relates to the technical field of uranium ore exploration, and in particular to a parameter determination method and apparatus for a uranium fission prompt neutron logging model, and a storage medium.

### BACKGROUND

Currently, the most important uranium ore exploration logging technology in our country is y logging, which performs exploration mainly using y rays generated by uranium series daughter nuclide, and then calculates a uranium content of an ore body according to uranium-radium equilibrium, so the y logging is the important basis for evaluating a uranium resource reserve. It is an indirect uranium-measuring and logging technology, and has inherent shortage of technical limitations for in-situ leachable sandstone-type uranium ores with serious uranium-radium destroy. However, the y logging cannot be used in a logging environment at all in which the uranium ore mines the remaining uranium content to monitor the variation of the uranium-radium equilibrium along the mining quantity, thus leading to the shortage of an effective technical means for monitoring the remaining uranium content during uranium ore mining.

The uranium fission prompt neutron logging is a measuring method that enables the uranium to generate fission in a manner that the uranium in the stratum is bombarded through neutrons emitted by a neutron source or a neutron generator, thus analyzing the uranium content in the stratum by measuring a uranium fission neutron signal, and currently also a more ideal direct uranium-measuring logging technology on the international.

The development of the uranium fission prompt neutron logging technology is inseparable from the measurement technological base with the uniform, accurate and reliable measurement unit, and also inseparable from the basic environment for the logging equipment testing and logging technology research. Designing and manufacturing the uranium fission prompt neutron logging parameter model are preconditions for solving the testing of a uranium fission prompt neutron logger, researching a uranium fission prompt neutron logging method and promoting the development of the uranium fission prompt neutron logging measurement technology.

At present, a feasible scheme, specifically designing a parameter model for the uranium fission prompt neutron logging technology, is unavailable at home and abroad.

### SUMMARY

To this end, the objective of the present disclosure is to provide a parameter determination method and apparatus for a uranium fission prompt neutron logging model, and a storage medium, to solve the problem that a feasible scheme, specifically designing a parameter model for the uranium fission prompt neutron logging technology, is unavailable at home and abroad.

According to a first aspect of the embodiment of the present disclosure, a parameter determination method for a uranium fission prompt neutron logging model is provided, and the method includes:
constructing the uranium fission prompt neutron logging model, setting quantitative parameters in the uranium fission prompt neutron logging model, and setting different exploration areas by taking an ore-bearing model wellhole center of the uranium fission prompt neutron logging model as an original point;
setting variable parameters in the uranium fission prompt neutron logging model, and simulating and calculating fluxes of a plurality of neutron types in the different exploration areas under the different variable parameters;
drawing a neutron flux variation curve chart of each neutron type in the different exploration areas under the different variable parameters based on the fluxes of the plurality of neutron types in the different exploration areas under the different variable parameters;
determining starting time, terminating time and a time window of the uranium fission prompt neutron of each neutron type based on the neutron flux variation curve chart of each neutron type;
determining an accumulated flux of the uranium fission prompt neutron of each neutron type based on the starting time, terminating time and time window of the uranium fission prompt neutron of each neutron type;
setting a reference ore-bearing model pore diameter, and determining the ore-bearing model pore diameter of the uranium fission prompt neutron logging model based on the reference pore diameter and the accumulated flux;
setting a reference ore-bearing model diameter, and determining the ore-bearing model diameter of the uranium fission prompt neutron logging model based on the reference ore-bearing model diameter and the accumulated flux; and
setting a reference ore-bearing model thickness, and determining the ore-bearing model thickness of the uranium fission prompt neutron logging model based on the reference ore-bearing model thickness and the accumulated flux.

Preferably,
the determining the ore-bearing model pore diameter of the uranium fission prompt neutron logging model based on the reference ore-bearing model pore diameter and the accumulated flux includes:
obtaining a first neutron flux relative value of different pore diameters in the different exploration areas compared with the reference ore-bearing model pore diameter based on the accumulated flux, drawing a relative variation curve of different neutron types in different pore diameters and different exploration spaces based on the first neutron flux relative value, and determining the ore-bearing model pore diameter of the uranium fission prompt neutron logging model based on the relative variation curve.

Preferably,
the determining the ore-bearing model diameter of the uranium fission prompt neutron logging model based on the reference ore-bearing model diameter and the accumulated flux includes:
obtaining a second neutron flux relative value of different ore-bearing model diameters in the different exploration areas compared with the reference ore-bearing model diameter based on the accumulated flux, drawing a relative variation curve of different neutron types in different ore-bearing model diameters and different exploration spaces based on the second neutron flux relative value, and determining the ore-bearing model diameter of the uranium fission prompt neutron logging model based on the relative variation curve.

Preferably,
the determining the ore-bearing model thickness of the uranium fission prompt neutron logging model based on the reference ore-bearing model thickness and the accumulated flux includes:
obtaining a third neutron flux relative value of different ore-bearing model thicknesses in different exploration areas compared with the reference ore-bearing model thickness based on the accumulated flux, drawing a relative variation curve of different neutron types in the different ore-bearing model thicknesses and different exploration spaces based on the third neutron flux relative value, and determining the ore-bearing model thickness of the uranium fission prompt neutron logging model based on the relative variation curve.

Preferably,
the setting the quantitative parameters in the uranium fission prompt neutron logging model includes:
setting contents of various chemical elements in the ore-bearing model and a surrounding rock model in the uranium fission prompt neutron logging model;
setting a wellhole of the uranium fission prompt neutron logging model and contents of air elements in a surrounding space;
setting the air of the uranium fission prompt neutron logging model, the surrounding rock model and a material density of the ore-bearing model; and
setting a neutron generator at a wellhole central position of the uranium fission prompt neutron logging model, and setting initial energy and a transmitting direction of the neutron;
the setting contents of various chemical elements in the ore-bearing model in the uranium fission prompt neutron logging model includes:
setting a total amount of a uranium element in the ore-bearing model, and the content of each uranium isotope.

Preferably,
the simulating and calculating the fluxes of the plurality of neutron types in the different exploration areas under the different variable parameters includes:
simulating and calculating the fluxes of the plurality of neutron types with the surrounding rock model instead of the ore-bearing model in the different exploration areas;
simulating and calculating the fluxes of the plurality of neutron types in different pore diameters and different exploration areas under the preset standard ore-bearing model thickness and the standard ore-bearing model diameter;
simulating and calculating the fluxes of the plurality of neutron types in different ore-bearing model diameters and different exploration areas under the preset standard ore-bearing model thickness and the standard pore diameter; and
simulating and calculating the fluxes of the plurality of neutron types in different ore-bearing model thicknesses and different exploration areas under the preset standard ore-bearing model diameter and the standard pore diameter.

Preferably,
the setting the different exploration areas by taking the ore-bearing model wellhole center of the uranium fission prompt neutron logging model as the original point includes:
taking a preset first thickness up and down as a first exploration area by taking the ore-bearing model wellhole center of the uranium fission prompt neutron logging model as the original point; and
equidistantly dividing the whole exploration space into a plurality of exploration areas in a preset second thickness from bottom to top by taking the first exploration area as a bottommost exploration area.

Preferably,
the plurality of neutron types include a thermal neutron, an epithermal neutron, a cadmium neutron, an epicadmium neutron, a slow neutron, a resonance neutron, an intermediate neutron and a fast neutron.

According to a second aspect of the embodiment of the present disclosure, a parameter determination apparatus for a uranium fission prompt neutron logging model is provided, and the apparatus includes:
a model construction module, configured to construct the uranium fission prompt neutron logging model, to set quantitative parameters in the uranium fission prompt neutron logging model, and to set different exploration areas by taking an ore-bearing model wellhole center of the uranium fission prompt neutron logging model as an original point;
a flux acquisition module, configured to set variable parameters in the uranium fission prompt neutron logging model, and to simulate and calculate fluxes of a plurality of neutron types in the different exploration areas under the different variable parameters;
a flux variation curve acquisition module, configured to draw a neutron flux variation curve chart of each neutron type in the different exploration areas under the different variable parameters based on the fluxes of the plurality of neutron types in the different exploration areas under the different variable parameters;
a time window acquisition module, configured to determine starting time, terminating time and a time window of the uranium fission prompt neutron of each neutron type based on the neutron flux variation curve chart of each neutron type;
an accumulated flux acquisition module, configured to determine an accumulated flux of the uranium fission prompt neutron of each neutron type based on the starting time, terminating time and time window of the uranium fission prompt neutron of each neutron type;
a pore diameter determination module, configured to set a reference ore-bearing model pore diameter, and to determine the ore-bearing model pore diameter of the uranium fission prompt neutron logging model based on the reference pore diameter and the accumulated flux;
an ore-bearing model diameter determination module, configured to set a reference ore-bearing model diameter, and to determine the ore-bearing model diameter of the uranium fission prompt neutron logging model based on the reference ore-bearing model diameter and the accumulated flux; and
an ore-bearing model thickness determination module, configured to set a reference ore-bearing model thickness, and determine the ore-bearing model thickness of the uranium fission prompt neutron logging model based on the reference ore-bearing model thickness and the accumulated flux.

According to a third aspect of the embodiment of the present disclosure, a storage medium is provided, where the storage medium stores a computer program, and while the computer program is executed by a main controller, various steps of the above method are implemented.

The technical solution provided by embodiments of the present disclosure may include the following beneficial effects:

The starting time, terminating time and time window of the uranium fission prompt neutron of each neutron type are determined in the present disclosure by constructing the uranium fission prompt neutron logging model, setting the quantitative parameters and exploration areas of the model, simulating and calculating flux time spectra of a plurality of neutron types under different variable parameters and comparing the time spectrum of the uranium fission prompt neutron with a background time spectrum. The accumulated flux of each neutron is determined according to the starting time, terminating time and time window, the reference ore-bearing model pore diameter, the reference ore-bearing model diameter and the reference ore-bearing model thickness are set, and the ore-bearing model pore diameter, ore-bearing model diameter and ore-bearing model thickness of the model are determined in respective by analyzing variation rules of reference quantities and the accumulated flux; and an accurate and feasible parameter determination method for a logging model and geometrical parameters are provided by the above solution.

It should be understood that general description above and the detailed description below are only illustrative and explanatory and do not restrict the present disclosure.

### BRIEF DESCRIPTION OF THE DRAWINGS

The drawings herein are incorporated into the specification and constitute part of the present disclosure, show the embodiment conforming to the present disclosure, are used together with the specification to explain the principles of the present disclosure.

FIG. 1 is a flow diagram of a parameter determination method for a uranium fission prompt neutron logging model according to one exemplary embodiment.

FIG. 2 is a diagram of a logging mode of a uranium fission prompt neutron logger according to another exemplary embodiment.

FIG. 3 is a geometric structure of a uranium fission prompt neutron logging parameter model according to another exemplary embodiment.

FIG. 4 is a comparison diagram for neutron flux time spectra in a surrounding rock model and an ore-bearing model according to another exemplary embodiment.

FIG. 5 is a relative variation diagram of a uranium fission prompt neutron flux of a logging parameter model of different pore diameters according to another exemplary embodiment.

FIG. 6 is a relative variation diagram of a uranium fission prompt neutron flux of a logging parameter model of different diameters according to another exemplary embodiment.

FIG. 6 is a relative variation diagram of a uranium fission prompt neutron flux of a logging parameter model of different thicknesses according to another exemplary embodiment.

FIG. 8 is a schematic diagram of a parameter determination apparatus for a uranium fission prompt neutron logging model according to another exemplary embodiment.

In the drawings: 1—model construction module; 2—flux acquisition module; 3—flux variation curve acquisition module; 4—time window acquisition module; 5—accumulated flux acquisition module; 6—pore diameter determination module; 7—ore-bearing model diameter determination module; and 8—ore-bearing model thickness determination module.

### DETAILED DESCRIPTION OF THE EMBODIMENTS

Exemplary embodiments are described here in detail, examples of which are represented in the drawings. Unless otherwise indicated, where the following descriptions relate to drawings, the same numbers in different drawings indicate the same or similar elements. The implementation mode described in the following exemplary embodiments do not represent all implementation modes consistent with the present disclosure. Instead, they are merely examples of devices and methods consistent with some aspects of the present disclosure as detailed in the attached claims.

### Embodiment I

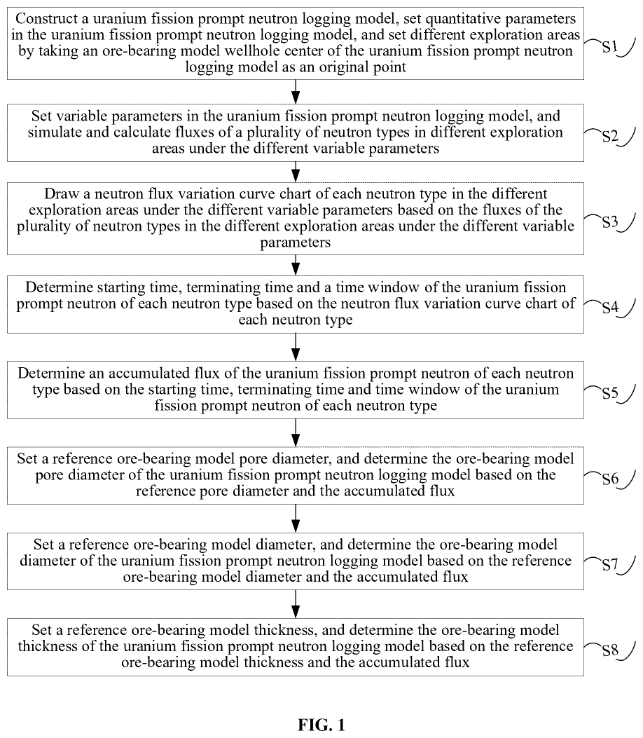

FIG. 1 is a flow diagram of a parameter determination method for a uranium fission prompt neutron logging model according to one exemplary embodiment, as shown in FIG. 1, the method includes:
S1: constructing the uranium fission prompt neutron logging model, setting quantitative parameters in the uranium fission prompt neutron logging model, and setting different exploration areas by taking an ore-bearing model wellhole center of the uranium fission prompt neutron logging model as an original point;
S2: setting variable parameters in the uranium fission prompt neutron logging model, and simulating and calculating fluxes of a plurality of neutron types in the different exploration areas under the different variable parameters;
S3: drawing a neutron flux variation curve chart of each neutron type in the different exploration areas under the different variable parameters based on the fluxes of the plurality of neutron types in the different exploration areas under the different variable parameters;
S4: determining starting time, terminating time and a time window of the uranium fission prompt neutron of each neutron type based on the neutron flux variation curve chart of each neutron type;
S5: determining an accumulated flux of the uranium fission prompt neutron of each neutron type based on the starting time, terminating time and time window of the uranium fission prompt neutron of each neutron type;
S6: setting a reference ore-bearing model pore diameter, and determining the ore-bearing model pore diameter of the uranium fission prompt neutron logging model based on the reference ore-bearing model pore diameter and the accumulated flux;
S7: setting a reference ore-bearing model diameter, and determining the ore-bearing model diameter of the uranium fission prompt neutron logging model based on the reference ore-bearing model diameter and the accumulated flux; and
S8: setting a reference ore-bearing model thickness, and determining the ore-bearing model thickness of the uranium fission prompt neutron logging model based on the reference ore-bearing model thickness and the accumulated flux.

It may be understood that the common pulsed neutron logging technology is mainly applied in the oil field and a logging technology for evaluating remaining oil, the pulsed neutron logging is a nuclear logging method and has the principle of detecting whether or not the content of various substances in the well meets the index during oil extraction by using interaction of the pulse neutron and the stratum, to ensure the safety during oil extraction, and the pulsed neutron logging technology involved in the implementation of the method specifically includes pulsed neutron saturation logging, pulsed neutron oxygen activation water flow logging and pulsed neutron porosity logging.

Developed on the basis of the pulsed neutron logging technology, the uranium fission prompt neutron logging is a direct uranium-measuring and logging technology specifically used for uranium ore exploration and mining. This technology uses 14.1 MeV neutrons generated by a deuterium-tritium (D-T) neutron source, ²³⁵U fission is caused after the 14.1 MeV neutrons are moderated through the stratum, new neutrons generated through the fission are moderated again in a stratum medium, the formed secondary neutrons continue to cause the ²³⁵U fission or enter the logger sensor to be detected, the uranium content in the stratum is determined through epithermal neutron and thermal neutron information generated during the detector measurement, and the neutrons are divided into 10 types according to the kinetic energy of the free neutrons:
\textcircled{1} Cold neutron (0 eV-0.025 eV): the neutron is in a thermal equilibrium state in a very cold environment (such as liquid deuterium), and the neutron of this part of energy is mainly used for the neutron scattering experiment.
\textcircled{2} Thermal neutron (0.025 eV): meaning that the neutron and the surrounding medium are in a thermal equilibrium state, the most probable maxwell's distribution of the neutron in a 20° C. environment is 0.025 eV (about 2.2 km/s), and the neutron of this part is the key neutron in a thermal reactor.
\textcircled{3} Epithermal neutron (0.025 eV-0.4 eV): the kinetic energy of this part of neutron is greater than its thermal energy, and to achieve a relatively high fuel breeding rate, some reactors use the epithermal neutron.
\textcircled{4} Cadmium neutron (0.4 eV-0.5 eV): the kinetic energy of the neutron is lower than the absorption cutoff energy of cadmium (¹³³Cd), so the neutron is easily absorbed by the cadmium.
\textcircled{5} Epicadmium neutron (0.5 eV-1 eV): the kinetic energy of the neutron is lower than the cadmium cutoff energy, so the neutron is not absorbed by the cadmium.
\textcircled{6} Slow neutron (1 eV-10 eV).
\textcircled{7} Resonance neutron (10 eV-300 eV): the neutron in this energy section may occur a special resonance absorption with substances, the neutron section is increased by 100 times or above compared with a background value, and under this energy, the neutron capture exceeds the fission probability obviously, allowing the fission probability of the thermal reactor to increase.
\textcircled{8} Intermediate neutron (300 eV-1 MeV).
\textcircled{9} Fast neutron (1 MeV-20 MeV): neutrons with the kinetic energy greater than 1 MeV (˜15000 km/s) is usually referred to as fission neutrons, and these neutrons are generated by the nuclear fission or (a, n) reaction, have a maxwell-boltzmann energy distribution, and an average energy (for ²³⁵UJ fission) of 2 MeV.
\textcircled{1}0 High-energy neutron (>20 MeV).

In the whole process from the neutron generation to the neutron being measured, the uranium fission prompt neutron logging needs to consider 8 neutron types of different kinetic energy from the thermal neutron to the fast neutron, therefore the flux variation situations of these 8 types of neutrons need to be researched for the design of the uranium fission prompt neutron logging parameter model, and meanwhile the uranium fission prompt neutron logging parameter model is usually designed to a cylinder structure according to the convenience for implementing the uranium ore body structure and model.

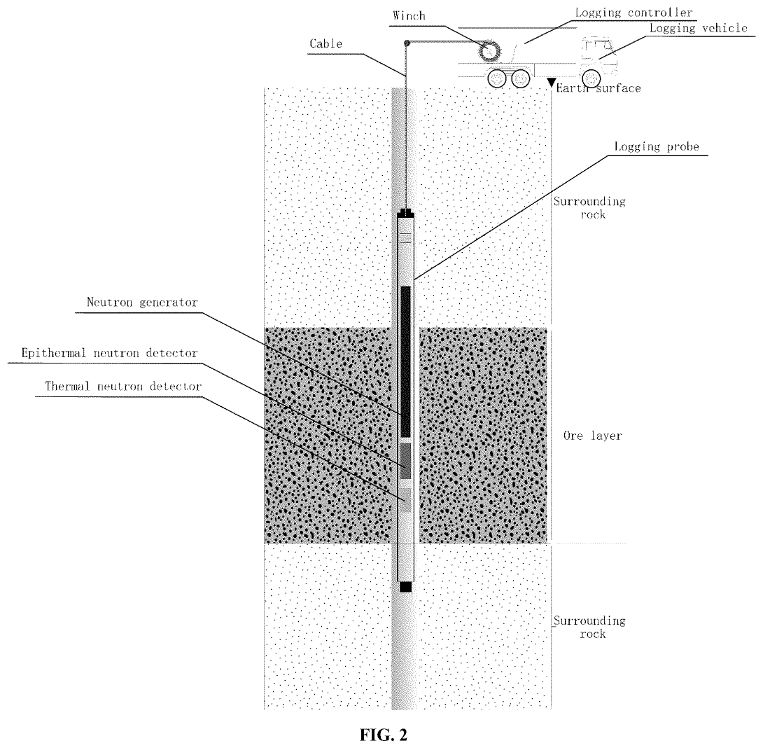

As shown in FIG. 2, the uranium fission prompt neutron logger is composed of a neutron logging probe, a logging controller and the like, where the neutron logging probe is composed of a neutron generator, a thermal neutron detector, an epithermal neutron detector, a measuring controller, a power source, a communication module and the like; and usually, the logging probe is 60 mm in diameter, the neutron generator in the probe is 650 mm in length, the epithermal neutron detector is 300 mm in length, the thermal neutron detector is 200 mm in length, the logging depth of the neutron logger is generally 0-1500 m, and according to needs of uranium exploration and mining and logging, a logging winch, a cable, car decking and other auxiliary equipment are equipped.

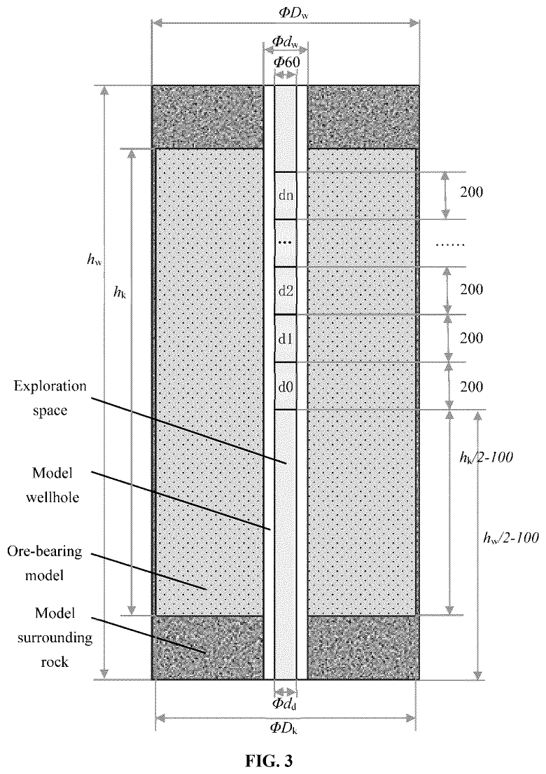

As shown in FIG. 3, according to the isotropy characteristic of the D-T neutron transmitted by the uranium fission prompt neutron logging probe, the logging parameter model is designed to a cylinder structure, the diameter and thickness of the model surrounding rock are set as D_{w} and h_{w}, the diameter and thickness of the ore-bearing model are set as Dₖ and hₖ, the inner diameter of the model wellhole is φdw (hole diameter), the diameter of the exploration space is dd-60 mm (consistent with the diameter of the logging probe), 100 mm is taken up and down with the ore-bearing model wellhole center as the original point to serve as the first exploration space, and the exploration space is divided into n parts with an equal distance of 200 mm from bottom to top, and the n parts are denoted as d₀, d₁, d₂, . . . ,dₙ;

The setting for the above quantitative parameters includes:

The contents of the surrounding rock elements in the uranium fission prompt neutron logging parameter model are set as Si-30.92%, Al-1.19%, Fe-2.13%, Ca-13.85%, Mg-0.51%, Mn-0.02%, Ti-0.07%, P-0.02%, K-0.21%, Na-0.12%, C-0.99%, S-0.64%, H-0.29% and 0-49.04%; and to ensure the accuracy of the simulated calculation result, the U element in the ore-bearing model is set as 1%, and other elements are reduced in an equal proportion according to the element content of the model surrounding rock.

$${C}_{i} = {C}_{i \text{.0}} \times 99 \%$$

In the formula, Cᵢ is the content of the i^{th} element in the ore-bearing model, and C_{i.0} is the content of the i^{th} element in the surrounding rock model;

The abundance of the natural uranium element is ²³⁴U-0.0057%, ²³⁵U-0.7204% and ²³⁸U-99.2739%, and therefore the isotope U in the ore-bearing model is set according to the following formula:

$${C}_{i . u} = {C}_{i . u \text{.0}} \times 1 \%$$

In the formula, C_{i.u} is the content of the i^{th} uranium isotope in the ore-bearing model, and C_{i.u0} is the content of the i^{th} uranium isotope in the natural uranium element.

The air element content in the model wellhole and the surrounding air is set as C-0.01%, N-75.53%, O-23.18% and Ar-1.28%.

According to the related data, the density of the above material is set as 0.001293 g/cm³ for the air, 2.0 g/cm³ for the surrounding rock model, and 2.0 g/cm³ for the ore-bearing model;

The D-T neutron source is set at the position of the do central point in the wellhole exploration space of the logging parameter model, with initial energy of 14.1 MeV, a transmitting direction of uniform transmission in 4x space, and a transmitting duration of instant transmission; The setting for the above variable parameters includes:

A Monte Carlo simulation mathematical model is established according to a geometric structure, a material element or a nuclide composition, a density and other parameters of the uranium fission prompt neutron logging parameter model, and according to the related reference data, the surrounding rock of the model is set as h_{w}=12.01m, φD_{w}=10.01m. According to the neutron classification, the time of flight (ToF) of the neutron is set as 0-104 us for the thermal neutron (Nt), epithermal neutron (Net), cadmium neutron ((Nc), epicadmium neutron (Nec), slow neutron (Ns), resonance neutron (Nr), intermediate neutron (Nin) and fast neutron (Nf) in d₀, d₁, d₂, . . . ,d₇ units, and then the simulated calculation is carried out:
(1) The thickness, diameter and pore diameter of the ore-bearing model are set as hₖ=12 m (the above standard ore-bearing model thickness), φDₖ=100 mm (the above standard ore-bearing model diameter) and φd_{w}=100 mm (the above standard pore diameter) (in this case, only surrounding rock model rather than the ore-bearing model is available), and the simulated calculation for the neutron flux of the background model is carried out.
(2) The thickness and diameter of the ore-bearing model are set as hₖ=12 m and φDₖ=10 m, and the pore diameter φd_{w} is separately set as 62, 70, 80, 90, 100, 120, 150, 180, 200, 250 and 300 mm, to carry out the simulated calculation for the neutron flux of different pore diameters.
(3) The ore-bearing model thickness is as hₖ=12 m, the ore-bearing model diameter φDₖ is separately set as 600, 800, 1000, 1200, 1300, 1400, 1500, 1600, 1800, 2000 and 10000 mm, and the pore diameter is φd_{w}=100 mm, to carry out the simulated calculation for the neutron flux of different ore-bearing model diameters.
(4) The ore-bearing model thickness hₖ is separately set as 100, 200, 300, 400, 500, 600, 700, 800, 900, 1000, 1200, 1400, 1600, 1800 and 2000 mm, the ore-bearing model diameter is φDₖ=10 m, and the pore diameter is φd_{w}=100 mm, to carry out the simulated calculation for the neutron flux of different ore-bearing model thicknesses.

### The Variation Curve Diagram of the Neutron Flux:

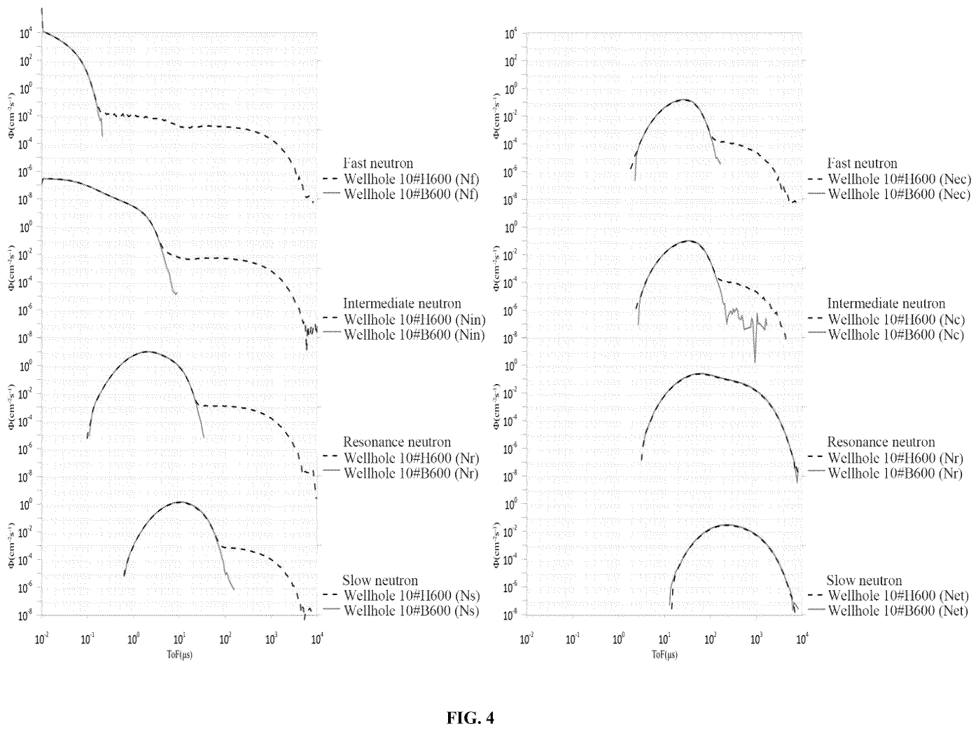

According to the simulated calculation result, the neutron flux variation situations of the surrounding rock model and the full ore-bearing model are compared, to determine the width of the accumulated time window of the uranium fission prompt neutron flux (Φ), as shown in FIG. 4, where the dotted curve is the neutron flux time spectrum in the full ore-bearing model, and the solid curve is the neutron flux time spectrum of the surrounding rock model. It has found through comparison that the D-T neutron generated by the logging probe neutron generator disappears directly after lasting for a certain time in the surrounding rock model, while the D-T neutron in the ore-bearing model generates a distinguishable secondary neutron after lasting for a certain time, this neutron is the uranium fission prompt neutron, and the secondary neutron drops to 100 times or below of the initial value after lasting for a certain time, which will not generate a macro impact on the logging result of the uranium fission prompt neutron any more; and the neutron flux accumulated time period set to catch the secondary neutron is referred to as the time window, it can be seen from the drawings that different types of uranium fission prompt neutrons have different starting time and terminating time except that Nt and Net cannot be distinguished, thus determining that the setting parameters for the starting time, terminating time and width of the time window of the uranium fission prompt neutron logging are as shown in Table 1:

TABLE 1
setting parameter table for the time window
of the uranium fission prompt neutron logging

| | Starting | Terminating | Window |
|---|---|---|---|
| Neutron type | time (μs) | time (μs) | width (μs) |
| Fast neutron | 0.2 | 1000 | 999.8 |
| Intermediate neutron | 20 | 1500 | 1480 |
| Resonance neutron | 50 | 1000 | 950 |
| Slow neutron | 200 | 2500 | 2300 |
| Epicadmium neutron | 200 | 2500 | 2300 |
| Cadmium neutron | 300 | 2500 | 2200 |
| Epithermal neutron | 300 | 2500 | 2200 |
| Thermal neutron | 300 | 2500 | 2200 |

### Determination for Accumulated Flux:

The parameters are set according to the determined time window, the flux accumulated calculation for the uranium fission prompt neutron is carried out by the following formula, to obtain the flux accumulated result of different types of uranium fission prompt neutrons, and the calculation formula is as follows:

$${Φ}_{i} = {\sum }_{j = {t}_{1}}^{j = t} {Φ}_{i . j}$$

In the formula, Φᵢ is the accumulated flux of the i^{th} uranium fission prompt neutron, s⁻¹/cm²; Φ_{i.j} is the count of the j μs^{th} flux of the i^{th} uranium fission prompt neutron, s⁻¹/cm²; t₁ is the starting time of the distinguishable uranium fission prompt neutron, μs; and t₂ is the terminating time of the uranium fission prompt neutron with the macro impact, μs;

### Determination of Pore Diameter:

The simulated result of the ore-bearing model hₖ=12m, φDₖ=10m, with a pore diameter of φd_{w}=62 mm (reference pore diameter) serves as the flux reference value of the uranium fission prompt neutron, and the flux relative value of the uranium fission prompt neutron of other pore diameters is calculated according to the following formula, as shown below:

$${R}_{i . j . k} = \frac{{Φ}_{i . j . k}}{{Φ}_{i \text{.62} . k}} \times 100 \%$$

In the formula, R_{i.j.k} is the flux relative value of the i^{th} uranium fission prompt neutron in the k^{th} exploration area of the j^{th} pore diameter model; Φ_{i.j.k} is the accumulated flux of the i^{th} uranium fission prompt neutron in the k^{th} exploration area of the j^{th} pore diameter model, s⁻¹/cm²; Φ_{i.62.k} is the accumulated flux of the i^{th} uranium fission prompt neutron in the k^{th} exploration space of the φd_{w}=(62 mm pore diameter model, s⁻¹/cm²; where i takes the 8 neutron types of Nt-Nf, j takes the 11 situations of the above 962-300 mm, and k takes the 8 situations of 0-1400 mm.

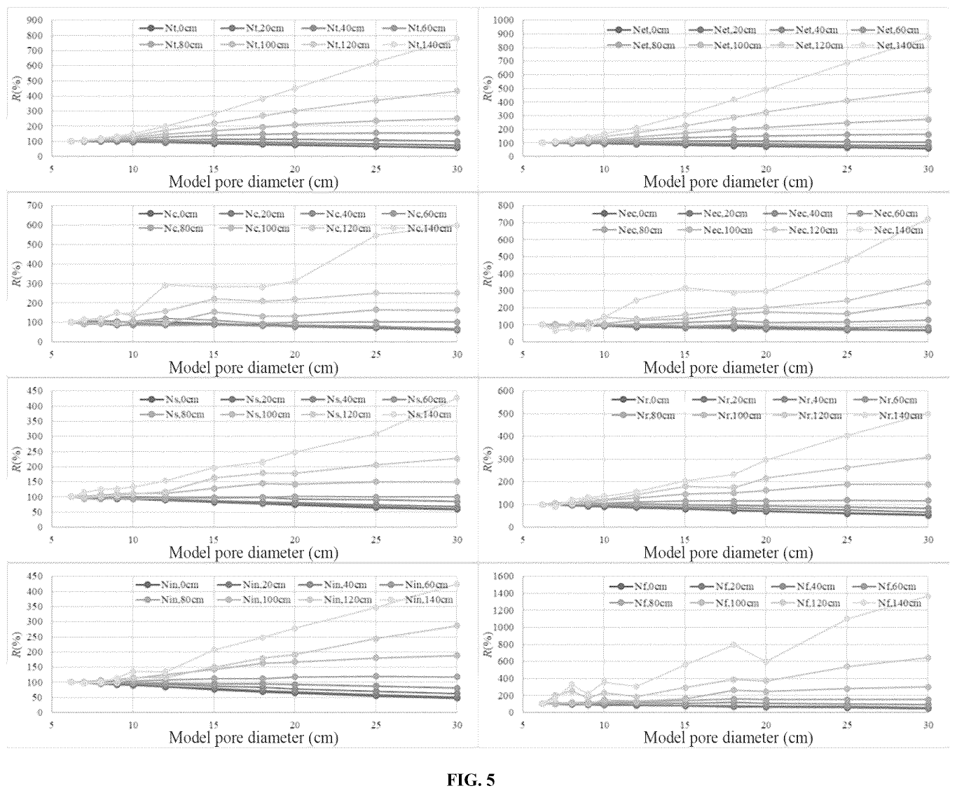

Through calculation, the relative variation curve of Nt-Nf (8 neutron types) flux in different pore diameters and different exploration areas is obtained, as shown in FIG. 5; it can be found from figures that the neutron flux decreases with the increase of the pore diameter in the d₀-d₃ (spacing 0-600 mm) exploration area, where the thermal neutron flux of do exploration space varies in 56%-100%, when the pore diameter is 100 mm, the neutron flux is reduced to about 95% of the reference value, while in the d₄-d₇ (spacing 800-1400 mm) exploration area, the neutron flux increases with the increase of the pore diameter, where the thermal neutron flux in d₄ exploration space varies in 100%-156%, and d₇ varies in 100%-800%;

Generally, the uranium fission prompt neutron logging probe has a diameter of about 60 mm, the spacing may be kept within 500 mm, and therefore the pore diameter of the logging parameter model shall be determined in 70-100 mm to ensure the actual work need that the probe can slide freely in the wellhole; at this time, the flux variations of the thermal neutron, epithermal neutron, cadmium neutron, epicadmium neutron, slow neutron, resonance neutron, intermediate neutron and fast neutron are 95%-107%, 93%-106%, 85%-107%, 92%-103%, 93%-101%, 89%-102%, 89%-100% and 86%-104%; and except that the impact on the cadmium neutron, resonance neutron and intermediate neutron is slightly great, the pore diameter impact on other uranium fission prompt neutrons is within the reasonable range.

### Determination of Ore-Bearing Model Diameter:

The simulated result of the ore-bearing model thickness hₖ=12m, the ore-bearing model diameter φDₖ=10m (refer to the ore-bearing model diameter) and the pore diameter of φd_{w}=100 mm serves as the flux reference value of the uranium fission prompt neutron, and the flux relative value of the uranium fission prompt neutron of other ore-bearing model diameters is calculated according to the following formula, as shown below:

$${R}_{i . j . k} = \frac{{Φ}_{i . j . k}}{{Φ}_{i \text{.10} . k}} \times 100 \%$$

In the formula, R_{i.j.k} is the flux relative value of the i^{th} uranium fission prompt neutron in the k^{th} exploration area of the j^{th} ore-bearing model diameter; Φ_{i.j.k} is the accumulated flux of the i^{th} uranium fission prompt neutron in the k^{th} exploration area of the j^{th} ore-bearing model diameter, s⁻¹/cm²; Φ_{i.10.k} is the accumulated flux of the i^{th} uranium fission prompt neutron in the k^{th} exploration space of the φDₖ=φ10 m ore-bearing model diameter (refer to the ore-bearing model diameter), s⁻¹/cm²; where i takes the 8 neutron types of Nt-Nf, j takes the 10 situations of φDₖ in 600-2000 mm, and k takes the 8 situations of 0-1400 mm.

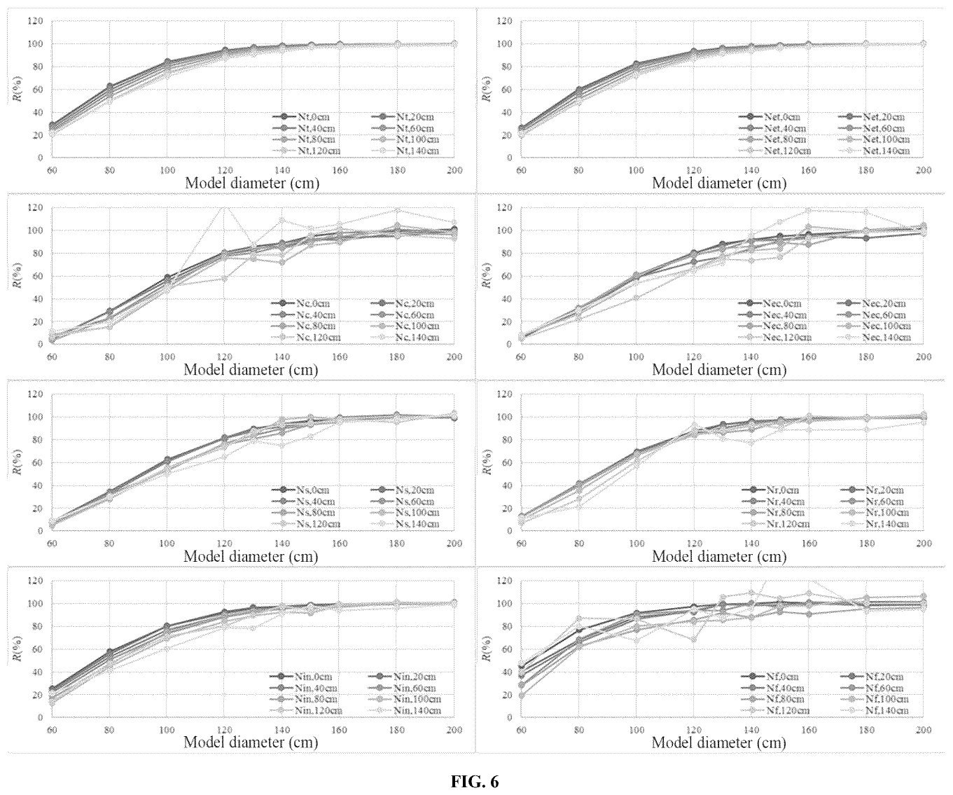

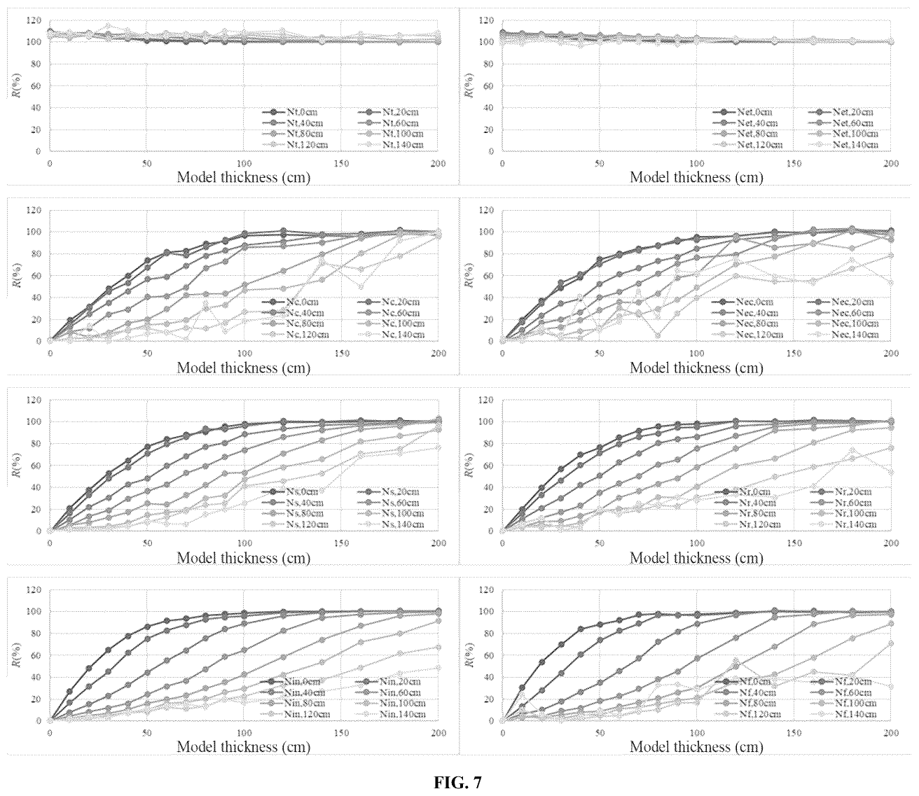

Through calculation, the relative variation curve of Nt-Nf flux in different diameters and different exploration spaces is obtained, as shown in FIG. 6; it can be found from FIG. 6 that the neutron flux increases with the increase of the model diameter in the d₀-d₃ (spacing 0-600 mm) exploration area, some simulated results are affected by the calculation accuracy in the d₄-d₇ (spacing 800-140 0 mm) exploration area. According to the requirement that, in the logging probe, the spacing of the epithermal neutron detector does not exceed 300 mm and the spacing of the thermal neutron detector does not exceed 600 mm, it shall consider that, in the d₀-d₃ (spacing 0-600 mm) exploration space, the thermal neutron flux of the ore-bearing model φ1500 mm or above is 98.3% or above of the reference value, the epithermal neutron is 98.1% or above of the reference value, the cadmium neutron is 90.4% or above of the reference value, the epicadmium neutron is 90.9% or above of the reference value, the slow neutron is 92.9% or above of the reference value, the resonance neutron is 96.1% or above of the reference value, the intermediate neutron is 96.6% or above of the reference value and the fast neutron is 96.0% or above of the reference value. In addition to the cadmium neutron, epicadmium neutron and slow neutron, other uranium fission prompt neutrons reach 95% or above of the reference value, and therefore the ore-bearing model diameter shall be determined in φDₖ1500˜2000 mm, to meet the saturation need of the model. Determination of ore-bearing model thickness:

The simulated result of the ore-bearing model thickness hₖ=12m (refer to the ore-bearing model thickness), the ore-bearing model diameter φDₖ=10 m and the pore diameter φd_{w}=100 mm serves as the flux reference value of the uranium fission prompt neutron, and the flux relative value of the uranium fission prompt neutron of other thicknesses is calculated according to the following formula, as shown below:

$${R}_{i . j . k} = \frac{{Φ}_{i . j . k}}{{Φ}_{i \text{.12} . k}} \times 100 \%$$

In the formula, R_{i.j.k} is the flux relative value of the i^{th} uranium fission prompt neutron in the k^{th} exploration area of the j^{th} ore-bearing model thickness; Φ_{i.j.k} is the accumulated flux of the i^{th} uranium fission prompt neutron in the k^{th} exploration area of the j^{th} ore-bearing model thickness, s⁻¹/cm²; Φ_{i.10.k} is the accumulated flux of the i^{th} uranium fission prompt neutron in the k^{th} exploration space of the ore-bearing model thickness hₖ=12m (refer to the ore-bearing model thickness), s⁻¹/cm²; where i takes the 8 neutron types of Nt-Nf, j takes the 15 situations of the ore-bearing model thickness hₖ in 100-2000 mm, and k takes the 8 situations of 0-1400 mm.

Through calculation, the relative variation curve of Nt-Nf flux in different ore thicknesses and different exploration spaces is obtained, as shown in FIG. 7; it can be found from FIG. 7 that, except for the accuracy impact of the simulated calculation, the fluxes of the thermal neutron and the epithermal neutron in the model basically remain unchanged, to completely meet the need that the spacing of the thermal neutron detector of the logging probe is within 600 mm, and the fluxes of other types of uranium fission prompt neutrons increase with the increase of the model thickness, and considering the need that the spacing of the epithermal neutron detector of the probe is only 300 mm, in the d₀-d2 (spacing 0-400 mm) exploration space, the flux of the cadmium neutron with the ore-bearing model thickness 1200 mm or above is 91.2% or above of the reference, the flux of the epicadmium neutron is 92.7% of the reference value, the flux of the slow neutron is 93.3% of the reference value, the flux of the resonance neutron is 95.6% of the reference value, the flux of the intermediate neutron is 95.9% of the reference value, and the flux of the fast neutron is 96.6% of the reference value. Considering that a 600 mm thick region is in the center of the logging parameter model, the ore-bearing model thickness of the logging parameter model shall be determined to 1800 mm.

In conclusion, according to the above simulated calculation and analysis result, a neutron logging parameter model with a saturated diameter and practical thickness is designed, and the parameter setting is as follows: the ore-bearing model needs to be determined as the cylinder structure with the diameter of φDₖ=1500 mm, thickness of 1800 mm and pore diameter of φd_{w}=100 mm.

The starting time, terminating time and time window of the uranium fission prompt neutron of each neutron type are determined in the present disclosure by constructing the uranium fission prompt neutron logging model, setting the quantitative parameters and exploration areas of the model, simulating and calculating flux time spectra of a plurality of neutron types under different variable parameters and comparing the time spectrum of the uranium fission prompt neutron with a background time spectrum. The accumulated flux of each neutron is determined according to the starting time, terminating time and time window, the reference ore-bearing model pore diameter, the reference ore-bearing model diameter and the reference ore-bearing model thickness are set, and the ore-bearing model pore diameter, ore-bearing model diameter and ore-bearing model thickness of the model are determined in respective by analyzing variation rules of reference quantities and the accumulated flux; and an accurate and feasible parameter determination method for a logging model and geometrical parameters are provided by the above solution.

### Embodiment II

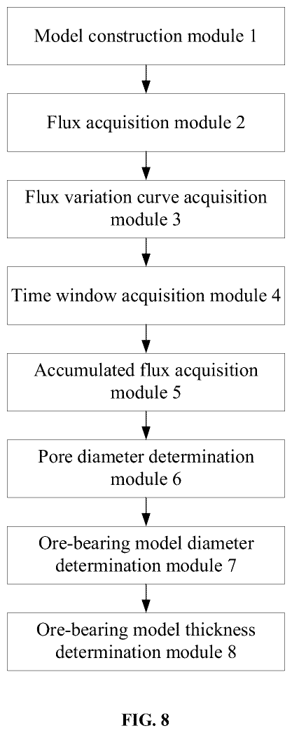

FIG. 8 is a schematic diagram of a parameter determination apparatus for a uranium fission prompt neutron logging model according to another exemplary embodiment, and the apparatus includes:

a model construction module 1, configured to construct the uranium fission prompt neutron logging model, to set quantitative parameters in the uranium fission prompt neutron logging model, and to set different exploration areas by taking an ore-bearing model wellhole center of the uranium fission prompt neutron logging model as an original point;
a flux acquisition module 2, configured to set variable parameters in the uranium fission prompt neutron logging model, and to simulate and calculate fluxes of a plurality of neutron types in the different exploration areas under the different variable parameters;
a flux variation curve acquisition module 3, configured to draw a neutron flux variation curve chart of each neutron type in the different exploration areas under the different variable parameters based on the fluxes of the plurality of neutron types in the different exploration areas under the different variable parameters;
a time window acquisition module 4, configured to determine starting time, terminating time and a time window of the uranium fission prompt neutron of each neutron type based on the neutron flux variation curve chart of each neutron type;
an accumulated flux acquisition module 5, configured to determine an accumulated flux of the uranium fission prompt neutron of each neutron type based on the starting time, terminating time and time window of the uranium fission prompt neutron of each neutron type;
a pore diameter determination module 6, configured to set a reference ore-bearing model pore diameter, and to determine the ore-bearing model pore diameter of the uranium fission prompt neutron logging model based on the reference pore diameter and the accumulated flux;
an ore-bearing model diameter determination module 7, configured to set a reference ore-bearing model diameter, and to determine the ore-bearing model diameter of the uranium fission prompt neutron logging model based on the reference ore-bearing model diameter and the accumulated flux; and
an ore-bearing model thickness determination module 8, configured to set a reference ore-bearing model thickness, and determine the ore-bearing model thickness of the uranium fission prompt neutron logging model based on the reference ore-bearing model thickness and the accumulated flux.

It can be understood that the model construction module 1 is used for constructing the uranium fission prompt neutron logging model, setting the quantitative parameters in the uranium fission prompt neutron logging model, and setting different exploration areas with the center of the ore-bearing model of the uranium fission prompt neutron logging model as the original point; the flux acquisition module 2 is used for setting the quantitative parameters in the uranium fission prompt neutron logging model, and simulating and calculating the fluxes of a plurality of neutron types in different exploration areas under different variable parameters; the flux variation curve acquisition module 3 is used for drawing a neutron flux variation curve chart of each neutron type in the different exploration areas under the different quantitative parameters based on the fluxes of the plurality of neutron types in the different exploration areas under the different variable parameters; the time window acquisition module 4 is used for determining starting time, terminating time and a time window of the uranium fission prompt neutron of each neutron type based on the neutron flux variation curve chart of each neutron type; the accumulated flux acquisition module 5 is used for determining an accumulated flux of the uranium fission prompt neutron of each neutron type based on the starting time, terminating time and time window of the uranium fission prompt neutron of each neutron type; the pore diameter determination module 6 is used for setting a reference ore-bearing model pore diameter, and determining the ore-bearing model pore diameter of the uranium fission prompt neutron logging model based on the reference pore diameter and the accumulated flux; the ore-bearing model diameter determination module 7 is used for setting a reference ore-bearing model diameter, and determining the ore-bearing model diameter of the uranium fission prompt neutron logging model based on the reference ore-bearing model diameter and the accumulated flux; and the ore-bearing model thickness determination module 8 is used for setting a reference ore-bearing model thickness, and determining the ore-bearing model thickness of the uranium fission prompt neutron logging model based on the reference ore-bearing model thickness and the accumulated flux.

### Embodiment III

A storage medium is provided in this embodiment, where the storage medium stores a computer program, and while the computer program is executed by a main controller, various steps of the above method are implemented.

It can be understood that the storage medium mentioned above may be a read-only memory, a magnetic disk, or a compact disk, etc.

It can be understood that the same or similar parts in the above embodiments may be referred to each other, and the contents not described in detail in some embodiments can refer to the same or similar contents in other embodiments.

It is to be noted that in the description of the present disclosure, the terms “first”, “second” and the like are merely used for description, instead of being understood as indicating or implying relative importance. In addition, in the description of the present disclosure, “a plurality of” means two or above two, unless specific limitation otherwise.

The flowchart or any process or method described herein in other methods may be understood as representing the inclusion of one or more modules, fragments or parts for implementing executable instructions of steps of a special logic function or process, moreover the scope of the preferred implementation of the present disclosure includes another realization, the shown or discussed sequence may not be referred, including the execution of the function in a basically simultaneous form or an opposite sequence according to the involved function, which should be understood by those skilled in the art of the embodiments of the present disclosure.

It is understood that various parts of the present disclosure may be implemented by using hardware, software, firmware or a combination thereof. In the above-mentioned implementation mode, a plurality of steps or methods may be implemented by the software or firmware stored in the memory and executed by the suitable instruction execution system. For example, if the hardware is used for implementation, like another implementation mode, any one or combination of the following technologies known in the art may be used for implementation: a discrete logic circuit with a logic gate circuit used for achieving a logic function of a data signal, an application-specific integrated circuit with a suitable combined logic gate circuit, a programmable gate array (PGA), a field-programmable gate array (FPGA), etc.

Those of ordinary skill in the art may understand that all or partial carried steps implementing the above embodiment method may be completed in a manner that the related hardware is instructed through the program, the program may be stored in a computer-readable storage medium, and when the program is executed, it may include one of steps of the method embodiment or a combination thereof.

In addition, functional units in each embodiment of the present disclosure may be integrated into one processing module, or each unit may have separate physical existence, or two or more units may be integrated in one module. The integrated module may be implemented in a software form, or may be implemented in form of hardware and software function module. If the integrated module is achieved in the form of software function modules and sold or used as independent products, the function may be stored in a computer readable storage medium.

The storage medium mentioned above may be a read-only memory, a magnetic disk, or a compact disk, etc.

In the description of the specification, the descriptions of reference terms “one embodiment”, “some embodiments”, “example”, “specific example”, or “some examples” intend to be included in at least one embodiment or example of the present disclosure in combination with the specific characteristics, structures, materials or characteristics of this embodiment or example. In this specification, the schematic expression of the above terms does not need for the same embodiment or example. Moreover, the described specific characteristics, structures, materials or characteristics may be combined in one or more embodiments or examples in a suitable manner.

Although the embodiments of the present disclosure have been shown and described above, it is understood that the above embodiments are exemplary instead of being understood as a limitation to the present disclosure. Those of ordinary skill in the art may make change, modification, replacement and deformation to the above embodiments within the scope of the present disclosure.

What is claimed is:

1. A parameter determination method for a uranium fission prompt neutron logging model, comprising:
constructing the uranium fission prompt neutron logging model, setting quantitative parameters in the uranium fission prompt neutron logging model, and setting different exploration areas by taking an ore-bearing model wellhole center of the uranium fission prompt neutron logging model as an original point;
setting variable parameters in the uranium fission prompt neutron logging model, and simulating and calculating fluxes of a plurality of neutron types in the different exploration areas under the different variable parameters;
drawing a neutron flux variation curve chart of each neutron type in the different exploration areas under the different variable parameters based on the fluxes of the plurality of neutron types in the different exploration areas under the different variable parameters;
determining starting time, terminating time and a time window of the uranium fission prompt neutron of each neutron type based on the neutron flux variation curve chart of each neutron type;
determining an accumulated flux of the uranium fission prompt neutron of each neutron type based on the starting time, terminating time and time window of the uranium fission prompt neutron of each neutron type;
setting a reference ore-bearing model pore diameter, and determining the ore-bearing model pore diameter of the uranium fission prompt neutron logging model based on the reference ore-bearing model pore diameter and the accumulated flux;
setting a reference ore-bearing model diameter, and determining the ore-bearing model diameter of the uranium fission prompt neutron logging model based on the reference ore-bearing model diameter and the accumulated flux; and
setting a reference ore-bearing model thickness, and determining the ore-bearing model thickness of the uranium fission prompt neutron logging model based on the reference ore-bearing model thickness and the accumulated flux.

2. The method according to claim 1, wherein
the determining the ore-bearing model pore diameter of the uranium fission prompt neutron logging model based on the reference ore-bearing model pore diameter and the accumulated flux comprises:
obtaining a first neutron flux relative value of different pore diameters in the different exploration areas compared with the reference ore-bearing model pore diameter based on the accumulated flux, drawing a relative variation curve of different neutron types in different pore diameters and different exploration spaces based on the first neutron flux relative value, and determining the ore-bearing model pore diameter of the uranium fission prompt neutron logging model based on the relative variation curve.

3. The method according to claim 1, wherein
the determining the ore-bearing model diameter of the uranium fission prompt neutron logging model based on the reference ore-bearing model diameter and the accumulated flux comprises:
obtaining a second neutron flux relative value of different ore-bearing model diameters in the different exploration areas compared with the reference ore-bearing model diameter based on the accumulated flux, drawing a relative variation curve of different neutron types in different ore-bearing model diameters and different exploration spaces based on the second neutron flux relative value, and determining the ore-bearing model diameter of the uranium fission prompt neutron logging model based on the relative variation curve.

4. The method according to claim 1, wherein
the determining the ore-bearing model thickness of the uranium fission prompt neutron logging model based on the reference ore-bearing model thickness and the accumulated flux comprises:
obtaining a third neutron flux relative value of different ore-bearing model thicknesses in different exploration areas compared with the reference ore-bearing model thickness based on the accumulated flux, drawing a relative variation curve of different neutron types in the different ore-bearing model thicknesses and different exploration spaces based on the third neutron flux relative value, and determining the ore-bearing model thickness of the uranium fission prompt neutron logging model based on the relative variation curve.

5. The method according to claim 1, wherein
the setting the quantitative parameters in the uranium fission prompt neutron logging model comprises:
setting contents of various chemical elements in the ore-bearing model and a surrounding rock model in the uranium fission prompt neutron logging model;
setting a wellhole of the uranium fission prompt neutron logging model and contents of air elements in a surrounding space;
setting the air of the uranium fission prompt neutron logging model, the surrounding rock model and a material density of the ore-bearing model; and
setting a neutron generator at a wellhole central position of the uranium fission prompt neutron logging model, and setting initial energy and a transmitting direction of the neutron;
the setting the contents of the various chemical elements in the ore-bearing model in the uranium fission prompt neutron logging model comprises:
setting a total amount of a uranium element in the ore-bearing model, and the content of each uranium isotope.

6. The method according to claim 5, wherein
the simulating and calculating the fluxes of the plurality of neutron types in the different exploration areas under the different variable parameters comprises:
simulating and calculating the fluxes of the plurality of neutron types with the surrounding rock model instead of the ore-bearing model in the different exploration areas;
simulating and calculating the fluxes of the plurality of neutron types in different pore diameters and different exploration areas under the preset standard ore-bearing model thickness and the standard ore-bearing model diameter;
simulating and calculating the fluxes of the plurality of neutron types in different ore-bearing model diameters and different exploration areas under the preset standard ore-bearing model thickness and the standard pore diameter; and
simulating and calculating the fluxes of the plurality of neutron types in different ore-bearing model thicknesses and different exploration areas under the preset standard ore-bearing model diameter and the standard pore diameter.

7. The method according to claim 1, wherein
the setting the different exploration areas by taking the ore-bearing model wellhole center of the uranium fission prompt neutron logging model as the original point comprises:
taking a preset first thickness up and down as a first exploration area by taking the ore-bearing model wellhole center of the uranium fission prompt neutron logging model as the original point; and
equidistantly dividing the whole exploration space into a plurality of exploration areas in a preset second thickness from bottom to top by taking the first exploration area as a bottommost exploration area.

8. The method according to claim 1, wherein
the plurality of neutron types comprise a thermal neutron, an epithermal neutron, a cadmium neutron, an epicadmium neutron, a slow neutron, a resonance neutron, an intermediate neutron and a fast neutron.

9. A parameter determination apparatus for a uranium fission prompt neutron logging model, comprising:
a model construction module, configured to construct the uranium fission prompt neutron logging model, to set quantitative parameters in the uranium fission prompt neutron logging model, and to set different exploration areas by taking an ore-bearing model wellhole center of the uranium fission prompt neutron logging model as an original point;
a flux acquisition module, configured to set variable parameters in the uranium fission prompt neutron logging model, and to simulate and calculate fluxes of a plurality of neutron types in the different exploration areas under the different variable parameters;
a flux variation curve acquisition module, configured to draw a neutron flux variation curve chart of each neutron type in the different exploration areas under the different variable parameters based on the fluxes of the plurality of neutron types in the different exploration areas under the different variable parameters;
a time window acquisition module, configured to determine starting time, terminating time and a time window of the uranium fission prompt neutron of each neutron type based on the neutron flux variation curve chart of each neutron type;
an accumulated flux acquisition module, configured to determine an accumulated flux of the uranium fission prompt neutron of each neutron type based on the starting time, terminating time and time window of the uranium fission prompt neutron of each neutron type;
a pore diameter determination module, configured to set a reference ore-bearing model pore diameter, and to determine the ore-bearing model pore diameter of the uranium fission prompt neutron logging model based on the reference ore-bearing model pore diameter and the accumulated flux;
an ore-bearing model diameter determination module, configured to set a reference ore-bearing model diameter, and to determine the ore-bearing model diameter of the uranium fission prompt neutron logging model based on the reference ore-bearing model diameter and the accumulated flux; and
an ore-bearing model thickness determination module, configured to set a reference ore-bearing model thickness, and to determine the ore-bearing model thickness of the uranium fission prompt neutron logging model based on the reference ore-bearing model thickness and the accumulated flux.

10. A storage medium, wherein the storage medium stores a computer program, and while the computer program is executed by a main controller, various steps of the parameter determination method for the uranium fission prompt neutron logging model according to claim 1 are implemented.
